(19) United States
(12) Patent Application Publication
(10) Pub. No.: US 2024/0235333 A9
(43) Pub. Date: Jul. 11, 2024

(54) POSITION DETECTION DEVICE, POSITION DETECTION METHOD, AUTOMATED GUIDED VEHICLE, AND SEWING DEVICE

(71) Applicants: NIDEC INSTRUMENTS CORPORATION, Nagano (JP); NIDEC CORPORATION, Kyoto (JP)

(72) Inventors: Yutaka SAITO, Nagano (JP); Atsushi FUJITA, Kyoto (JP)

(21) Appl. No.: 18/547,330

(22) PCT Filed: Jan. 21, 2022
(86) PCT No.: PCT/JP2022/002240

§ 371 Date: Aug. 21, 2023

(30) Foreign Application Priority Data
Feb. 22, 2021 (JP) 2021-026281

(51) Int. Cl. H02K 11/215; D05B 19/04; H02K 29/08; H02P 6/16

(52) U.S. Cl. CPC H02K 11/215; D05B 19/04; H02K 29/08; H02P 6/16; H02P 2101/45

(57) ABSTRACT

A position detection device includes: a first group including N (a multiple of 3) first magnetic sensors facing a magnet that rotates in synchronization with a rotation shaft of a motor and arranged at intervals along a rotation direction of the magnet, and a second group including N second magnetic sensors arranged opposite respectively to the N first magnetic sensors across the rotation shaft in a radial direction of the magnet; and a signal processing device processing output signals respectively output from the first and second magnetic sensors. The signal processing device executes averaging processing of generating N average signals by averaging an output signal of the first magnetic sensor and an output signal of the second magnetic sensor arranged at the position opposite to the first magnetic sensor across the rotation shaft, and estimation processing of estimating a rotational position of the motor based on the N average signals.

### CROSS-REFERENCE TO RELATED APPLICATIONS

This is the U.S. national stage of application No. PCT/JP2022/002240, filed on Jan. 21, 2022, and priority under 35 U.S.C. § 119(a) and 35 U.S.C. § 365(b) is claimed from Japanese Patent Application No. 2021-026281, filed on Feb. 22, 2021.

### FIELD OF THE INVENTION

The present invention relates to a position detection device, a position detection method, an automated guided vehicle, and a sewing device.

### BACKGROUND

Conventionally, a configuration including an absolute angle position sensor such as an optical encoder and a resolver is known as a motor capable of accurately controlling a rotational position. However, the absolute angle position sensor is large in size and high in cost. Therefore, a method of estimating a rotational position of a motor using three inexpensive and small magnetic sensors without using an absolute angle position sensor has been known.

In the position estimation method described above, when a specific case occurs, there is a possibility that the estimation accuracy of the rotational position decreases. The specific case is a case in which the rotor shaft rotates in a state where the central axis of the rotor shaft is eccentric with respect to the central axis of a position detection magnet, and a case in which the rotor shaft rotates in a state where the position detection magnet is inclined with respect to a plane orthogonal to the rotor shaft. In these cases, the amplitude values of output signals of the three magnetic sensors periodically fluctuate over one mechanical angle cycle due to a periodic change of a void between the position detection magnet and the three magnetic sensors.

### SUMMARY

One aspect in an exemplary position detection device of the present invention provides a position detection device that detects a rotational position of a motor, the position detection device including: a first sensor group including N (N is a multiple of 3) first magnetic sensors facing a magnet that rotates in synchronization with a rotation shaft of the motor and arranged at predetermined intervals along a rotation direction of the magnet, and a second sensor group including N second magnetic sensors arranged at positions opposite respectively to the N first magnetic sensors across the rotation shaft in a radial direction of the magnet; and a signal processing device that processes output signals respectively output from the N first magnetic sensors and the N second magnetic sensors. The signal processing device executes averaging processing of generating N average signals by averaging an output signal of the first magnetic sensor and an output signal of the second magnetic sensor arranged at the position opposite to the first magnetic sensor across the rotation shaft, and estimation processing of estimating a rotational position of the motor based on the N average signals.

One aspect in an exemplary position detection method of the present invention provides a position detection method of detecting a rotational position of a motor, the position detection method including: a first step of acquiring an output signal of N (N is a multiple of 3) first magnetic sensors from a first sensor group including the N first magnetic sensors facing a magnet that rotates in synchronization with a rotation shaft of the motor and arranged at predetermined intervals along a rotation direction of the magnet; a second step of acquiring an output signal of N second magnetic sensors from a second sensor group including the N second magnetic sensors arranged at positions opposite respectively to the N first magnetic sensors across the rotation shaft in a radial direction of the magnet; a third step of generating N average signals by averaging an output signal of the first magnetic sensor and an output signal of the second magnetic sensor arranged at the position opposite to the first magnetic sensor across the rotation shaft; and a fourth step of estimating a rotational position of the motor based on the N average signals.

One aspect in an exemplary automated guided vehicle of the present invention provides a motor and the position detection device of the above aspect that detects a rotational position of the motor.

One aspect in an exemplary sewing device of the present invention provides a motor and the position detection device of the above aspect that detects a rotational position of the motor.

The above and other elements, features, steps, characteristics and advantages of the present disclosure will become more apparent from the following detailed description of the preferred embodiments with reference to the attached drawings.

### BRIEF DESCRIPTION OF THE DRAWINGS

FIG. 1 is a block diagram schematically illustrating a configuration of a position detection device according to an embodiment of the present invention;

FIG. 2 is a flowchart showing learning processing executed by a processing unit in the present embodiment;

FIG. 3 is an explanatory diagram related to learning data acquired by the learning processing in the present embodiment;

FIG. 4 is an enlarged view of three average signals included in one pole pair region;

FIG. 5 is a flowchart showing position estimation processing executed by the processing unit in the present embodiment;

FIG. 6 is a view schematically illustrating a first case in which a rotor shaft rotates in a state where a central axis of the rotor shaft is eccentric with respect to a central axis of a sensor magnet;

FIG. 7 is a view schematically illustrating a second case in which the rotor shaft rotates in a state where the sensor magnet is inclined with respect to a plane orthogonal to the rotor shaft;

FIG. 8 is a view illustrating waveforms of first Hall signals output from three first magnetic sensors and waveforms of second Hall signals output from three second magnetic sensors in the first and second cases;

FIG. 9 is a view illustrating waveforms of three average signals calculated based on the first Hall signals output from the three first magnetic sensors and the second Hall signals output from the three second magnetic sensors;

FIG. 10 is a view illustrating an appearance of an automated guided vehicle that is an application example of the present invention; and

FIG. 11 is a view illustrating an appearance of a sewing device that is an application example of the present invention.

### DETAILED DESCRIPTION

An embodiment of the present invention will be described in detail below with reference to the drawings.

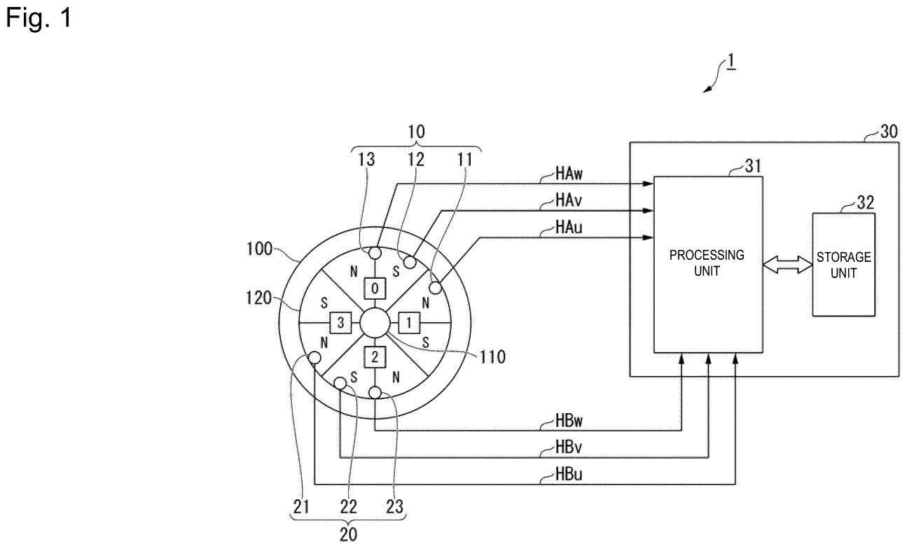

FIG. 1 is a block diagram schematically illustrating the configuration of a position detection device 1 in one embodiment of the present invention. As illustrated in FIG. 1, the position detection device 1 is a device that detects a rotational position (rotation angle) of a motor 100. In the present embodiment, the motor 100 is, for example, an inner rotor type three-phase brushless DC motor. The motor 100 includes a rotor shaft 110 and a sensor magnet 120. The rotor shaft 110 is a rotation shaft of the motor 100. The rotational position of the motor 100 means the rotational position of the rotor shaft 110.

The sensor magnet 120 is a disk-shaped magnet attached to the rotor shaft 110. The sensor magnet 120 rotates in synchronization with the rotor shaft 110. The sensor magnet 120 has P (P is an integer of 2 or more) magnetic pole pairs. In the present embodiment, as an example, the sensor magnet 120 has four magnetic pole pairs. The magnetic pole pair means a pair of an N pole and an S pole. That is, in the present embodiment, the sensor magnet 120 has four pairs of N poles and S poles, and has a total of eight magnetic poles.

The position detection device 1 includes a first sensor group 10, a second sensor group 20, and a signal processing device 30. The first sensor group 10 includes N (N is a multiple of 3) first magnetic sensors. In the present embodiment, the first sensor group 10 includes three first magnetic sensors 11, 12, and 13. The second sensor group 20 includes N second magnetic sensors. In the present embodiment, the second sensor group 20 includes three second magnetic sensors 21, 22, and 23.

Although not illustrated in FIG. 1, a circuit board is mounted on the motor 100, and the first sensor group 10, the second sensor group 20, and the signal processing device 30 are arranged on the circuit board. The sensor magnet 120 is arranged at a position not interfering with the circuit board. The sensor magnet 120 may be arranged inside a housing of the motor 100 or may be arranged outside the housing.

On the circuit board, the first magnetic sensors 11, 12, and 13 face the sensor magnet 120 and are arranged at predetermined intervals along the rotation direction of the sensor magnet 120. In the present embodiment, the first magnetic sensors 11, 12, and 13 are arranged at 30° intervals along the rotation direction of the sensor magnet 120. For example, each of the first magnetic sensors 11, 12, and 13 is a Hall element or a linear Hall IC. The first magnetic sensors 11, 12, and 13 each outputs an analog signal that fluctuates according to the magnetic field strength.

One electrical angle cycle of each analog signal output from the first magnetic sensors 11, 12, and 13 corresponds to 1/P of one mechanical angle cycle. In the present embodiment, since the number of pole pairs P of the sensor magnet 120 is “4”, one electrical angle cycle of each analog signal corresponds to ¼ of one mechanical angle cycle, that is, 90° in the mechanical angle. The analog signals output from the first magnetic sensors 11, 12, and 13 have a phase difference of 120° from one another in electrical angle.

Hereinafter, the analog signals output from the first magnetic sensors 11, 12, and 13 are referred to as first Hall signals. The first magnetic sensor 11 outputs a first Hall signal HAu to the signal processing device 30. The first magnetic sensor 12 outputs a first Hall signal HAv to the signal processing device 30. The first magnetic sensor 13 outputs a first Hall signal HAw to the signal processing device 30.

On the circuit board, the second magnetic sensors 21, 22, and 23 are arranged at positions opposite to the respect three first magnetic sensors 11, 12, and 13 across the rotor shaft 110 in the radial direction of the sensor magnet 120. The second magnetic sensor 21 is arranged at a position opposite to the first magnetic sensor 11 across the rotor shaft 110 in the radial direction of the sensor magnet 120. The second magnetic sensor 22 is arranged at a position opposite to the first magnetic sensor 12 across the rotor shaft 110 in the radial direction of the sensor magnet 120. The second magnetic sensor 23 is arranged at a position opposite to the first magnetic sensor 13 across the rotor shaft 110 in the radial direction of the sensor magnet 120.

On the circuit board, the second magnetic sensors 21, 22, and 23 face the sensor magnet 120 and are arranged at predetermined intervals along the rotation direction of the sensor magnet 120. In the present embodiment, the second magnetic sensors 21, 22, and 23 are arranged at 30° intervals along the rotation direction of the sensor magnet 120. For example, each of the second magnetic sensors 21, 22, and 23 is a Hall element or a linear Hall IC. The second magnetic sensors 21, 22, and 23 each outputs an analog signal that fluctuates according to the magnetic field strength.

Similarly to the first magnetic sensors 11, 12, and 13, one electrical angle cycle of each analog signal output from the second magnetic sensors 21, 22, and 23 corresponds to 90° in mechanical angle. The analog signals output from the second magnetic sensors 21, 22, and 23 have a phase difference of 120° from one another in electrical angle.

Hereinafter, the analog signals output from the second magnetic sensors 21, 22, and 23 are referred to as second Hall signals. The second magnetic sensor 21 outputs a second Hall signal HBu to the signal processing device 30. The second magnetic sensor 22 outputs a second Hall signal HBv to the signal processing device 30. The second magnetic sensor 23 outputs a second Hall signal HBw to the signal processing device 30.

There is a phase difference of 180° in mechanical angle between the first Hall signal HAu output from the first magnetic sensor 11 and the second Hall signal HBu output from the second magnetic sensor 21. There is a phase difference of 180° in mechanical angle between the first Hall signal HAv output from the first magnetic sensor 12 and the second Hall signal HBv output from the second magnetic sensor 22. There is a phase difference of 180° in mechanical angle between the first Hall signal HAw output from the first magnetic sensor 13 and the second Hall signal HBw output from the second magnetic sensor 23.

The signal processing device 30 is a device that processes an output signal output from each of the three first magnetic sensors and the three second magnetic sensors. The signal processing device 30 estimates the rotational position of the motor 100, that is, the rotational position of the rotor shaft 110 based on the first Hall signals HAu, HAv, and HAw and the second Hall signals HBu, HBv, and HBw. The signal processing device 30 includes a processing unit 31 and a storage unit 32.

The processing unit 31 is a microprocessor such as a microcontroller unit (MCU), for example. The first Hall signals HAu, HAv, and HAw and the second Hall signals HBu, HBv, and HBw are input to the processing unit 31. The processing unit 31 is data-communicably connected to the storage unit 32 via a data bus not illustrated.

Note that the first Hall signal and the second Hall signal are converted into digital signals via an A/D converter inside the processing unit 31, but for convenience of description, the digital signals output from the A/D converter are also referred to as first Hall signal and second Hall signal. In the following description, the first Hall signal and the second Hall signal input to the processing unit 31 may be collectively referred to as “input sensor signal”.

The processing unit 31 executes at least the following two processing according to a program stored in the storage unit 32. The processing unit 31 executes learning processing of acquiring learning data necessary for estimation of the rotational position of the rotor shaft 110 based on the input sensor signal. The processing unit 31 executes position estimation processing of estimating the rotational position of the rotor shaft 110 based on the input sensor signal and the learning data.

The storage unit 32 includes a nonvolatile memory that stores programs necessary for causing the processing unit 31 to execute various processing, various setting values, learning data, and the like, and a volatile memory used as a temporary storage destination of data when the processing unit 31 executes various processing. The nonvolatile memory is, for example, an electrically erasable programmable read-only memory (EEPROM), a flash memory, or the like. The volatile memory is, for example, a random access memory (RAM) or the like.

Next, learning processing executed by the processing unit 31 will be described.

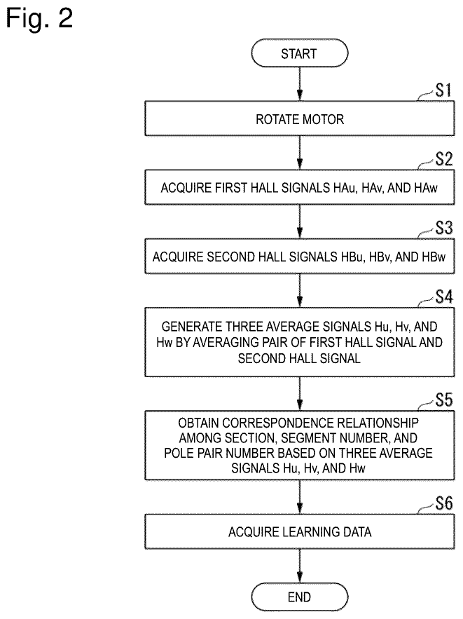

FIG. 2 is a flowchart showing the learning processing executed by the processing unit 31 in the present embodiment. The processing unit 31 executes the processing illustrated in FIG. 2 at least when the position detection device 1 is powered on for the first time.

As illustrated in FIG. 2, when starting the learning processing, the processing unit 31 first rotates the motor 100 to rotate the sensor magnet 120 together with the rotor shaft 110 (step S1). The processing unit 31 may rotate the rotor shaft 110 by controlling energization of the motor 100 via a motor control device not illustrated. Alternatively, the rotor shaft 110 may be connected to a rotating machine not illustrated, and the rotating machine may rotate the rotor shaft 110.

Then, the processing unit 31 acquires the first Hall signals HAu, HAv, and HAw output from the three first magnetic sensors 11, 12, and 13 along with the rotation of the sensor magnet 120 (step S2).

In parallel with step S2, the processing unit 31 acquires the second Hall signals HBu, HBv, and HBw output from the three second magnetic sensors 21, 22, and 23 along with the rotation of the sensor magnet 120 (step S3).

Then, the processing unit 31 generates three average signals by averaging the output signals of the first magnetic sensors and the output signals of the second magnetic sensors arranged at positions opposite to the first magnetic sensors across the rotor shaft 110 (step S4).

Specifically, the processing unit 31 generates an average signal Hu by averaging the first Hall signal HAu output from the first magnetic sensor 11 and the second Hall signal HBu output from the second magnetic sensor 21. The processing unit 31 generates an average signal Hv by averaging the first Hall signal HAv output from the first magnetic sensor 12 and the second Hall signal HBv output from the second magnetic sensor 22. The processing unit 31 generates an average signal Hw by averaging the first Hall signal HAw output from the first magnetic sensor 13 and the second Hall signal HBw output from the second magnetic sensor 23.

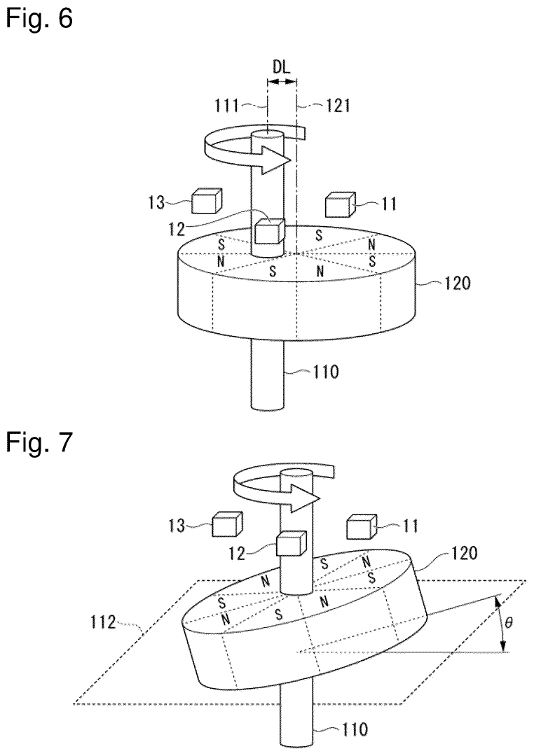

FIG. 6 is a view schematically illustrating the first case in which the rotor shaft 110 rotates in a state where a central axis 111 of the rotor shaft 110 is eccentric with displacement DL with respect to a central axis 121 of the sensor magnet 120. FIG. 7 is a view schematically illustrating the second case in which the rotor shaft 110 rotates in a state where the sensor magnet 120 is inclined at a deflection angle θ with respect to a plane 112 orthogonal to the rotor shaft 110.

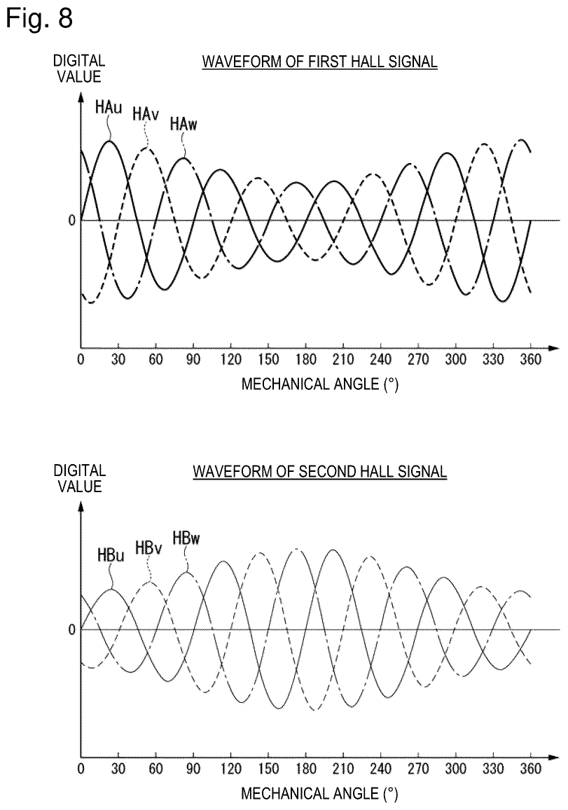

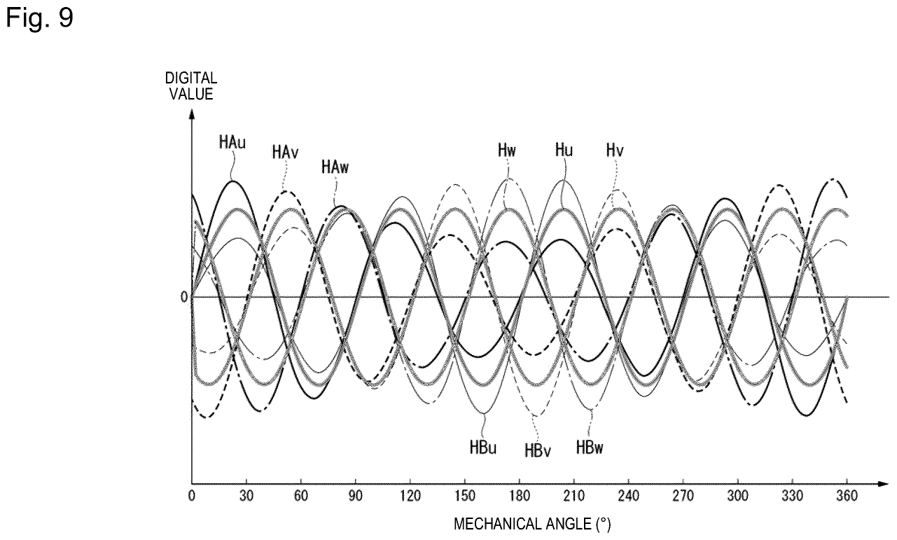

FIG. 8 is a view illustrating waveforms of the first Hall signals HAu, HAv, and HAw output from the first magnetic sensors 11, 12, and 13 and waveforms of the second Hall signals HBu, HBv, and HBw output from the second magnetic sensors 21, 22, and 23 in the first and second cases. FIG. 9 is a view illustrating waveforms of the three average signals Hu, Hv, and Hw calculated based on the first Hall signals HAu, HAv, and HAw and the second Hall signals HBu, HBv, and HBw.

In the first case and the second case, when the rotor shaft 110 rotates, a void between the sensor magnet 120 and the first magnetic sensors 11, 12, and 13 periodically changes. As a result, as illustrated in the waveform on the upper side of FIG. 8, the amplitude value of each of the first Hall signals HAu, HAv, and HAw periodically fluctuates over one mechanical angle cycle. As illustrated in FIG. 8, one electrical angle cycle of each of the first Hall signals HAu, HAv, and HAw corresponds to 90° in mechanical angle. The first Hall signals HAu, HAv, and HAw have a phase difference of 120° in electrical angle (30° in mechanical angle) from one another.

Although the second magnetic sensors 21, 22, and 23 are omitted in FIGS. 6 and 7, in the first case and the second case, when the rotor shaft 110 rotates, a void between the sensor magnet 120 and the second magnetic sensors 21, 22, and 23 also periodically changes. As a result, as illustrated in the waveform on the lower side of FIG. 8, the amplitude value of each of the second Hall signals HBu, HBv, and HBw also periodically fluctuates over one mechanical angle cycle. As illustrated in FIG. 8, one electrical angle cycle of each of the second Hall signals HBu, HBv, and HBw corresponds to 90° in mechanical angle. The second Hall signals HBu, HBv, and HBw have a phase difference of 120° in electrical angle (30° in mechanical angle) from one another.

As illustrated in FIG. 8, there is a phase difference of 180° in mechanical angle between the first Hall signal HAu and the second Hall signal HBu. There is a phase difference of 180° in mechanical angle between the first Hall signal HAv and the second Hall signal HBv. There is a phase difference of 180° in mechanical angle between the first Hall signal HAw and the second Hall signal HBw.

This means that a phase difference of 180° in mechanical angle also exists between the amplitude fluctuation cycle of the first Hall signal HAu and the amplitude fluctuation cycle of the second Hall signal HBu. Similarly, a phase difference of 180° in mechanical angle also exists between the amplitude fluctuation cycle of the first Hall signal HAv and the amplitude fluctuation cycle of the second Hall signal HBv. Furthermore, a phase difference of 180° in the mechanical angle also exists between the amplitude fluctuation cycle of the first Hall signal HAw and the amplitude fluctuation cycle of the second Hall signal HBw.

As described above, by averaging the pair of the first Hall signal and the second Hall signal whose amplitude values fluctuate with a phase difference of 180° in mechanical angle, it is possible to obtain the average signals Hu, Hv, and Hw having constant amplitude values over one mechanical angle cycle as illustrated in FIG. 9. As in the present embodiment, in a case where the sensor magnet 120 has an even number of magnetic pole pairs, the second Hall signal HBu has an amplitude fluctuation in which positive and negative polarities coincide with each other with a phase difference of 180° in mechanical angle with respect to the amplitude fluctuation caused in the first Hall signal HAu. The same applies to the relationship between the first Hall signal HAv and the second Hall signal HBv and the relationship between the first Hall signal HAw and the second Hall signal HBw.

In the case where the sensor magnet 120 has an even number of magnetic pole pairs as described above, the processing unit 31 adds, in step S4, the output signal of the first magnetic sensor and the output signal of the second magnetic sensor arranged at a position opposite to the first magnetic sensor across the rotor shaft 110, and divides the addition result by 2, thereby generating an average signal having a constant amplitude value over one mechanical angle cycle.

Specifically, the processing unit 31 adds the first Hall signal HAu and the second Hall signal HBu and divides the addition result by 2, thereby generating the average signal Hu having a constant amplitude value over one mechanical angle cycle. The processing unit 31 adds the first Hall signal HAv and the second Hall signal HBv and divides the addition result by 2, thereby generating the average signal Hv having a constant amplitude value over one mechanical angle cycle. The processing unit 31 adds the first Hall signal HAw and the second Hall signal HBw and divides the addition result by 2, thereby generating the average signal Hw having a constant amplitude value over one mechanical angle cycle.

Subsequently, as illustrated in FIG. 2, based on the three average signals Hu, Hv, and Hw obtained in step S4, the processing unit 31 divides one mechanical angle cycle into four pole pair regions associated with pole pair numbers representing the pole pair positions of the four magnetic pole pairs, further divides each of the four pole pair regions into a plurality of sections, and associates a segment number representing the rotational position of the rotor shaft 110 with each of the plurality of sections (step S5).

In the present embodiment, in order to estimate the rotational position of the rotor shaft 110, pole pair numbers representing the pole pair positions are assigned to the four magnetic pole pairs of the sensor magnet 120. For example, as illustrated in FIG. 1, the four magnetic pole pairs of the sensor magnet 120 are assigned with the pole pair numbers in the order of “0”, “1”, “2”, and “3” clockwise.

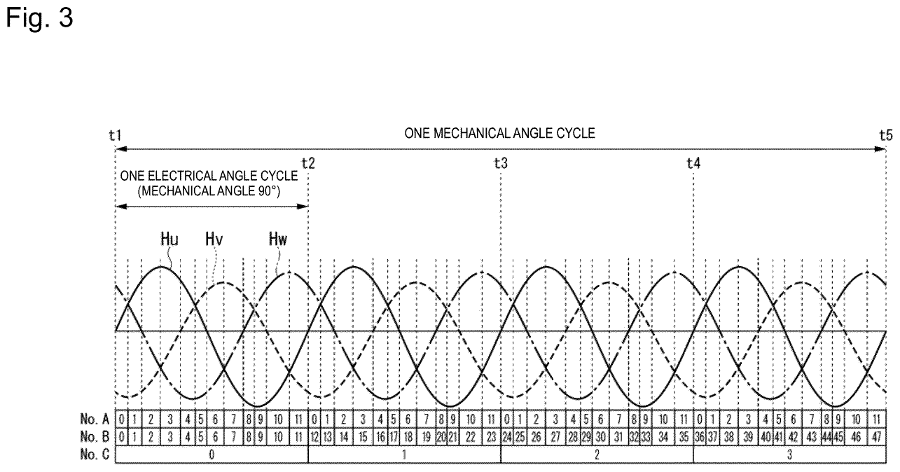

As illustrated in FIG. 3, the processing unit 31 divides one mechanical angle cycle into four pole pair regions based on the average signals Hu, Hv, and Hw obtained in one mechanical angle cycle. In FIG. 3, a period from time t1 to time t5 corresponds to one mechanical angle cycle. In FIG. 3, “No. C” indicates the pole pair number.

The processing unit 31 divides the period from time t1 to time t2 in one mechanical angle cycle as a pole pair region associated with the pole pair number “0”.

The processing unit 31 divides the period from time t2 to time t3 in one mechanical angle cycle as a pole pair region associated with the pole pair number “1”.

The processing unit 31 divides the period from time t3 to time t4 in one mechanical angle cycle as a pole pair region associated with the pole pair number “2”.

The processing unit 31 divides the period from time t4 to time t5 in one mechanical angle cycle as a pole pair region associated with the pole pair number “3”.

As illustrated in FIG. 3, the processing unit 31 further divides each of the four pole pair regions into 12 sections based on the three average signals Hu, Hv, and Hw obtained in one mechanical angle cycle, and associates a segment number representing the rotational position of the rotor shaft 110 with each of the 12 sections. In FIG. 3, “No. A” indicates the section number assigned to a section, and “No. B” indicates the segment number.

As illustrated in FIG. 3, the 12 sections included in each of the four pole pair regions are assigned with the section numbers from “0” to “11”. On the other hand, a number continuous over the entire period of one mechanical angle cycle is associated with each section as a segment number. Specifically, as illustrated in FIG. 3, in the pole pair region associated with the pole pair number “0”, the section numbers “0” to “11” are associated with the segment numbers “0” to “11”. In the pole pair region associated with the pole pair number “1”, the section numbers “0” to “11” are associated with the segment numbers “12” to “23”. In the pole pair region associated with the pole pair number “2”, the section numbers “0” to “11” are associated with the segment numbers “24” to “35”. In the pole pair region associated with the pole pair number “3”, the section numbers “0” to “11” are associated with the segment numbers “36” to “47”.

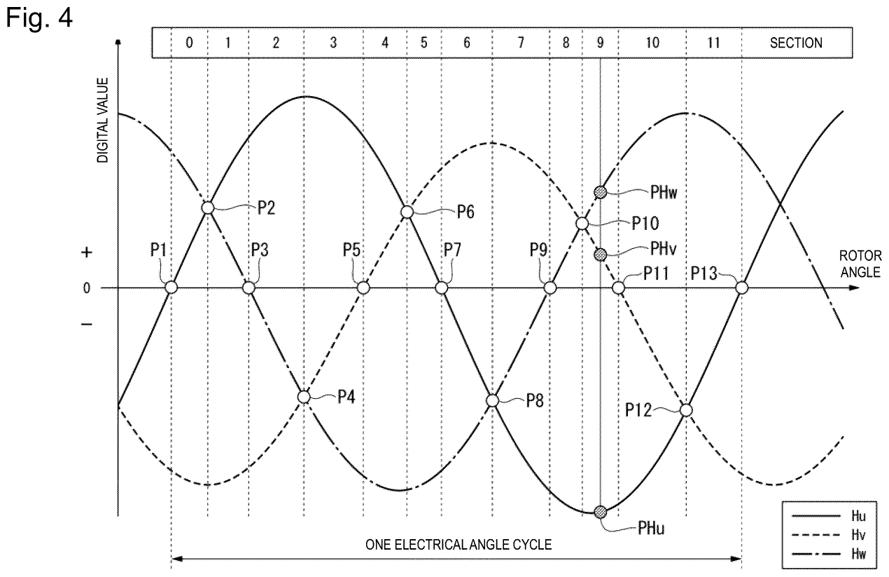

FIG. 4 is an enlarged view of the average signals Hu, Hv, and Hw included in one pole pair region. A method of dividing the pole pair region into the 12 sections will be described below with reference to FIG. 4. In FIG. 4, the reference value of amplitude is “0”. In FIG. 4, the digital value of amplitude that is a positive value represents a digital value of the magnetic field strength of the N pole, as an example. The digital value of amplitude that is a negative value represents a digital value of the magnetic field strength of the S pole, as an example.

The processing unit 31 extracts a zero cross point, which is a point at which the three average signals Hu, Hv, and Hw included in each of the four pole pair regions intersect the reference value “0”. As illustrated in FIG. 4, the processing unit 31 extracts a point P1, a point P3, a point P5, a point P7, a point P9, a point P11, and a point P13 as zero cross points.

Then, the processing unit 31 extracts an intersection point that is a point at which the three average signals Hu, Hv, and Hw included in each of the four pole pair regions intersect one another. As illustrated in FIG. 4, the processing unit 31 extracts a point P2, a point P4, a point P6, a point P8, a point P10, and a point P12 as intersection points. Then, the processing unit 31 determines, as a section, an interval between the zero cross point and the intersection point adjacent to each other.

As illustrated in FIG. 4, the processing unit 31 determines the interval between the zero cross point P1 and the intersection point P2 as the section assigned with the section number “0”.

The processing unit 31 determines the interval between the intersection point P2 and the zero cross point P3 as the section assigned with the section number “1”.

The processing unit 31 determines the interval between the zero cross point P3 and the intersection point P4 as the section assigned with the section number “2”.

The processing unit 31 determines the interval between the intersection point P4 and the zero cross point P5 as the section assigned with the section number “3”.

The processing unit 31 determines the interval between the zero cross point P5 and the intersection point P6 as the section assigned with the section number “4”.

The processing unit 31 determines the interval between the intersection point P6 and the zero cross point P7 as the section assigned with the section number “5”.

The processing unit 31 determines the interval between the zero cross point P7 and the intersection point P8 as the section assigned with the section number “6”.

The processing unit 31 determines the interval between the intersection point P8 and the zero cross point P9 as the section assigned with the section number “7”.

The processing unit 31 determines the interval between the zero cross point P9 and the intersection point P10 as the section assigned with the section number “8”.

The processing unit 31 determines the interval between the intersection point P10 and the zero cross point P11 as the section assigned with the section number “9”.

The processing unit 31 determines the interval between the zero cross point P11 and the intersection point P12 as the section assigned with the section number “10”.

The processing unit 31 determines the interval between the intersection point P12 and the zero cross point P13 as the section assigned with the section number “11”.

Furthermore, the processing unit 31 extracts, for each section, feature data such as a magnitude relationship between detection values of the average signals Hu, Hv, and Hw and positive and negative signs of each detection value, and associates the extracted feature data with the section number of each section.

By executing step S5 as described above, as illustrated in FIG. 3, one mechanical angle cycle is divided into the four pole pair regions associated with the pole pair numbers, each of the four pole pair regions is divided into 12 sections, and each section number of each section is associated with the segment number. Note that in the following description, for example, the section assigned with the section number “0” will be referred to as “0th section”, and the section assigned with the section number “11” will be referred to as “11th section”.

In the end, the processing unit 31 acquires, as learning data, the feature data associated with the section number and data indicating a correspondence relationship between the segment number representing the rotational position associated with the section number and the pole pair number representing the pole pair position, and stores the acquired learning data into the storage unit 32 (step S6).

Next, the position estimation processing executed by the processing unit 31 will be described.

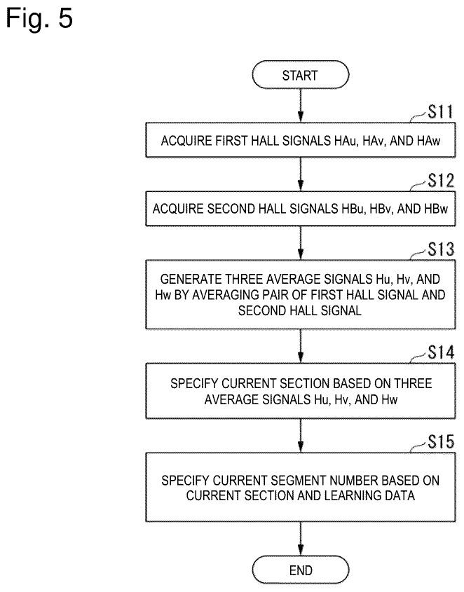

FIG. 5 is a flowchart showing the position estimation processing executed by the processing unit 31. After executing the above learning processing, the processing unit 31 executes the position estimation processing illustrated in FIG. 5 when the position detection device 1 is powered on again. The processing unit 31 repeatedly executes the position estimation processing illustrated in FIG. 5 at a predetermined cycle.

As illustrated in FIG. 5, when starting the position estimation processing, the processing unit 31 first acquires the three first Hall signals HAu, HAv, and HAw from the first sensor group 10 including the three first magnetic sensors 11, 12, and 13 (step S11). This step S11 corresponds to the first step in the position detection method of claim 6.

In parallel with step S11, the processing unit 31 acquires the three second Hall signals HBu, HBv, and HBw from the second sensor group 20 including the three second magnetic sensors 21, 22, and 23 (step S12). This step S12 corresponds to the second step in the position detection method of claim 6.

Then, the processing unit 31 executes the averaging processing of generating three average signals by averaging the output signal of the first magnetic sensor and the output signal of the second magnetic sensor arranged at a position opposite to the first magnetic sensor across the rotor shaft 110 (step S13). This step S13 corresponds to the third step in the position detection method of claim 6.

Similarly to the above learning processing, in the case where the sensor magnet 120 has an even number of magnetic pole pairs as described above, the processing unit 31 adds, in step S13, the output signal of the first magnetic sensor and the output signal of the second magnetic sensor arranged at a position opposite to the first magnetic sensor across the rotor shaft 110, and divides the addition result by 2, thereby generating an average signal having a constant amplitude value over one mechanical angle cycle.

Specifically, the processing unit 31 adds the first Hall signal HAu and the second Hall signal HBu and divides the addition result by 2, thereby generating the average signal Hu having a constant amplitude value over one mechanical angle cycle. The processing unit 31 adds the first Hall signal HAv and the second Hall signal HBv and divides the addition result by 2, thereby generating the average signal Hv having a constant amplitude value over one mechanical angle cycle. The processing unit 31 adds the first Hall signal HAw and the second Hall signal HBw and divides the addition result by 2, thereby generating the average signal Hw having a constant amplitude value over one mechanical angle cycle.

Then, the processing unit 31 executes the estimation processing of estimating the rotational position of the motor 100 based on the three average signals Hu, Hv, and Hw obtained in step S13 (steps S14 and S15). These steps S14 and S15 correspond to the fourth step in the position detection method of claim 6.

Specifically, the processing unit 31 specifies a current section from among the 12 sections based on the three average signals Hu, Hv, and Hw (step S14). For example, in FIG. 4, it is assumed that a point PHu positioned on the waveform of the average signal Hu, a point PHv positioned on the waveform of the average signal Hv, and a point PHw positioned on the waveform of the average signal Hw are detection values (digital values) of the respective average signals Hu, Hv, and Hw obtained at the time of execution of the position estimation processing this time. The processing unit 31 extracts the feature data such as the magnitude relationship among the detection values of the point PHu, the point PHv, and the point PHw and the positive and negative signs of each detection value, and collates the extracted feature data with the learning data stored in the storage unit 32, thereby specifying, as the current section, the section number associated with the feature data coinciding with the extracted feature data. In the example of FIG. 4, the ninth section is specified as the current section.

Then, the processing unit 31 determines the current segment number as the rotational position of the motor 100 based on the specified current section (section number) and the learning data stored in the storage unit 32 (step S15). For example, as described above, it is assumed that the ninth section is specified as the current section. It is assumed that the pole pair number at the time of execution of the current position estimation processing is “2”. In this case, as illustrated in FIG. 3, the processing unit 31 determines the segment number “33” as the rotational position of the motor 100.

As described above, in the first case in which the rotor shaft 110 rotates in a state where the central axis 111 of the rotor shaft 110 is eccentric with respect to the central axis 121 of the sensor magnet 120 and the second case in which the rotor shaft 110 rotates in a state where the sensor magnet 120 is inclined with respect to the plane 112 orthogonal to the rotor shaft 110, the amplitude values of the first Hall signals HAu, HAv, and HAw periodically fluctuate over one mechanical angle cycle due to the periodic change of the void between the sensor magnet 120 and the first magnetic sensors 11, 12, and 13.

Therefore, when the rotational position of the motor 100 is detected using only the three first magnetic sensors 11, 12, and 13 as in the conventional technique, if the first case or the second case occurs, correlation between the feature data extracted from the first Hall signals HAu, HAv, and HAw at the time of executing the position estimation processing and the feature data included in the learning data cannot be obtained, and there is a possibility that a wrong section number is specified as the current section. As a result, a wrong segment number is determined as the rotational position of the motor 100, and the detection accuracy of the rotational position decreases.

In the position detection device 1 of the present embodiment, the three second magnetic sensors are arranged at positions opposite to the respective three first magnetic sensors across the rotor shaft 110 in the radial direction of the sensor magnet 120. In this case, in the second Hall signal output from the second magnetic sensor, amplitude fluctuation occurs with a phase difference of 180° in mechanical angle with respect to amplitude fluctuation that occurs in the first Hall signal output from the paired first magnetic sensor. Therefore, by averaging the pair of the first Hall signal and the second Hall signal whose amplitude values fluctuate with a phase difference of 180° in mechanical angle, the position detection device 1 of the present embodiment obtains three average signals having constant amplitude values over one mechanical angle cycle.

Due to this, even if the first case or the second case occurs, correlation between the feature data extracted from the average signals Hu, Hv, and Hw at the time of execution of the position estimation processing and the feature data included in the learning data can be obtained, and an accurate section number can be specified as the current section. As a result, an accurate segment number can be determined as the rotational position of the motor 100, and a decrease in the detection accuracy of the rotational position can be suppressed.

In the present embodiment, the sensor magnet 120 has an even number of magnetic pole pairs. In this case, in the second Hall signal output from the second magnetic sensor, amplitude fluctuation in which positive and negative polarities coincide with each other with a phase difference of 180° in mechanical angle with respect to amplitude fluctuation that occurs in the first Hall signal output from the paired first magnetic sensor. Therefore, the position detection device 1 of the present embodiment can obtain an average signal having a constant amplitude value over one mechanical angle cycle by adding the output signal of the first magnetic sensor and the output signal of the second magnetic sensor arranged at a position opposite to the first magnetic sensor across the rotor shaft 110, and dividing the addition result by 2

In the present embodiment, the sensor magnet 120 is a disk-shaped magnet attached to the rotor shaft 110 of the motor 100. According to the present embodiment, when the sensor magnet 120 is used as a magnet for position detection, even if one of the first case in which the rotor shaft 110 rotates in a state where the central axis 111 of the rotor shaft 110 is eccentric with respect to the central axis 121 of the sensor magnet 120 and the second case in which the rotor shaft 110 rotates in a state where the sensor magnet 120 is inclined with respect to the plane 112 orthogonal to the rotor shaft 110 occurs, it is possible to suppress a decrease in detection accuracy of the rotational position.

The present invention is not limited to the above embodiment, and the configurations described in the present description can be appropriately combined within a range not conflicting with one another.

For example, in the above embodiment, the case where the sensor magnet 120 has an even number of magnetic pole pairs has been exemplified. In a case where the sensor magnet 120 has an odd number of magnetic pole pairs, the second Hall signal output from the second magnetic sensor has an amplitude fluctuation in which the positive and negative polarities are inverted with a phase difference of 180° in mechanical angle with respect to the amplitude fluctuation generated in the first Hall signal output from the paired first magnetic sensor.

Therefore, in the case where the sensor magnet 120 has an odd number of magnetic pole pairs, the processing unit 31 may generate, in step S13, the average signal by subtracting the output signal of the second magnetic sensor arranged at the position opposite to the first magnetic sensor across the rotor shaft 110 from the output signal of the first magnetic sensor, and dividing the subtraction result by 2. Due to this, even when the sensor magnet 120 has an odd number of magnetic pole pairs, it is possible to obtain an average signal having a constant amplitude value over one mechanical angle cycle.

In the above embodiment, the case where the sensor magnet 120 is used as a magnet for position detection, that is, a magnet that rotates in synchronization with the rotor shaft 110 of the motor 100 has been exemplified. However, the rotor magnet attached to the rotor of the motor 100 may be used as a magnet for position detection. The rotor magnet is also a magnet that rotates in synchronization with the rotor shaft 110, and has a plurality of magnetic pole pairs.

Due to this, when the rotor magnet is used as a magnet for position detection, even if one of the case where the rotor shaft 110 rotates in a state where the central axis 111 of the rotor shaft 110 is eccentric with respect to the central axis of the rotor magnet and the case where the rotor shaft 110 rotates in a state where the rotor magnet is inclined with respect to the plane 112 orthogonal to the rotor shaft 110 occurs, it is possible to suppress a decrease in detection accuracy of the rotational position.

In the above embodiment, the case where the first sensor group 10 includes the three first magnetic sensors 11, 12, and 13 and the second sensor group 20 includes the three second magnetic sensors 21, 22, and 23 has been exemplified. However, the number of the first magnetic sensors and the number of the second magnetic sensors are not limited to three, and may be N (N is a multiple of 3). In the above embodiment, the case where one set of the first sensor group and the second sensor group is provided has been exemplified, but a plurality of sets of the first sensor group and the second sensor group may be provided.

In the above embodiment, the case where the sensor magnet 120 has four magnetic pole pairs has been exemplified, but the number of pole pairs of the sensor magnet 120 is not limited to four. Similarly, when the rotor magnet is used as a magnet for position detection, the number of pole pairs of the rotor magnet is not limited to four.

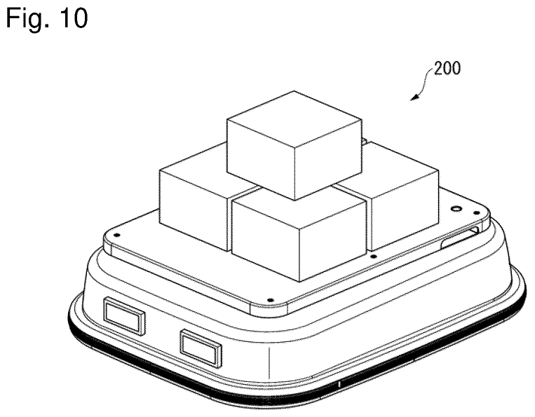

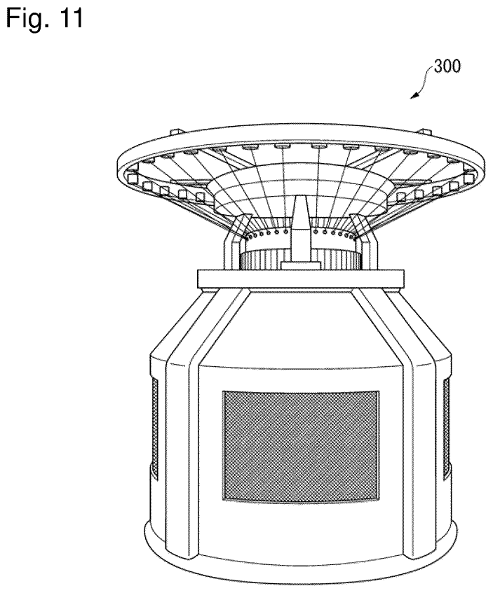

FIG. 10 is a view schematically illustrating an appearance of an automated guided vehicle 200, which is an application example of the present invention. FIG. 11 is a view schematically illustrating an appearance of a sewing device 300, which is an application example of the present invention. Each of the automated guided vehicle 200 and the sewing device 300 includes a motor and a position detection device that detects the rotational position of the motor. As the motor, the motor 100 described in the above embodiment can be used. As the position detection device, the position detection device 1 of the above embodiment can be used.

The application examples of the present invention are not limited to the automated guided vehicle 200 and the sewing device 300, and the present invention can be widely applied to a device driven by a motor such as a robot, for example.

Features of the above-described preferred embodiments and the modifications thereof may be combined appropriately as long as no conflict arises.

While preferred embodiments of the present disclosure have been described above, it is to be understood that variations and modifications will be apparent to those skilled in the art without departing from the scope and spirit of the present disclosure. The scope of the present disclosure, therefore, is to be determined solely by the following claims.

1. A position detection device that detects a rotational position of a motor, the position detection device comprising:
a first sensor group including N (N is a multiple of 3) first magnetic sensors facing a magnet that rotates in synchronization with a rotation shaft of the motor and arranged at predetermined intervals along a rotation direction of the magnet, and a second sensor group including N second magnetic sensors arranged at positions opposite respectively to the N first magnetic sensors across the rotation shaft in a radial direction of the magnet; and
a signal processing device that processes output signals respectively output from the N first magnetic sensors and the N second magnetic sensors, wherein
the signal processing device executes
averaging processing of generating N average signals by averaging an output signal of the first magnetic sensor and an output signal of the second magnetic sensor arranged at the position opposite to the first magnetic sensor across the rotation shaft, and
estimation processing of estimating a rotational position of the motor based on the N average signals.

2. The position detection device according to claim 1, wherein
the magnet has an even number of magnetic pole pairs, and
in the averaging processing, the signal processing device generates the average signals by adding an output signal of the first magnetic sensor and an output signal of the second magnetic sensor arranged at the position opposite to the first magnetic sensor across the rotation shaft, and dividing an addition result by 2.

3. The position detection device according to claim 1, wherein
the magnet has an odd number of magnetic pole pairs, and
in the averaging processing, the signal processing device generates the average signals by subtracting an output signal of the second magnetic sensor arranged at the position opposite to the first magnetic sensor across the rotation shaft from an output signal of the first magnetic sensor, and dividing a subtraction result by 2.

4. The position detection device according to claim 1, wherein
the magnet is a disk-shaped magnet attached to the rotation shaft of the motor.

5. The position detection device according to claim 1, wherein
the magnet is a rotor magnet attached to a rotor of the motor.

6. A position detection method of detecting a rotational position of a motor, the position detection method comprising:
a first step of acquiring an output signal of N (N is a multiple of 3) first magnetic sensors from a first sensor group including the N first magnetic sensors facing a magnet that rotates in synchronization with a rotation shaft of the motor and arranged at predetermined intervals along a rotation direction of the magnet;
a second step of acquiring an output signal of N second magnetic sensors from a second sensor group including the N second magnetic sensors arranged at positions opposite respectively to the N first magnetic sensors across the rotation shaft in a radial direction of the magnet;
a third step of generating N average signals by averaging an output signal of the first magnetic sensor and an output signal of the second magnetic sensor arranged at the position opposite to the first magnetic sensor across the rotation shaft; and
a fourth step of estimating a rotational position of the motor based on the N average signals.

7. The position detection method according to claim 6, wherein
the magnet has an even number of magnetic pole pairs, and
the third step includes
a step of adding an output signal of the first magnetic sensor and an output signal of the second magnetic sensor arranged at the position opposite to the first magnetic sensor across the rotation shaft, and a step of generating the average signals by dividing an addition result by 2.

8. The position detection method according to claim 6, wherein
the magnet has an odd number of magnetic pole pairs, and
the third step includes
a step of subtracting an output signal of the first magnetic sensor and an output signal of the second magnetic sensor arranged at the position opposite to the first magnetic sensor across the rotation shaft, and a step of generating the average signals by dividing a subtraction result by 2.

9. The position detection method according to claim 6, wherein
the magnet is a disk-shaped magnet attached to the rotation shaft of the motor.

10. The position detection method according to claim 6, wherein
the magnet is a rotor magnet attached to a rotor of the motor.

11. An automated guided vehicle comprising:
a motor; and
the position detection device according to claim 1 that detects a rotational position of the motor.

12. A sewing device comprising:
a motor; and
the position detection device according to claim 1 that detects a rotational position of the motor.
